(19) United States
(12) Patent Application Publication
(10) Pub. No.: US 2023/0083326 A1
(43) Pub. Date: Mar. 16, 2023

(54) SHOWERHEAD ATTACHMENT AND SHOWERHEAD HAVING THE SAME

(71) Applicant: Eli ZHADANOV, Brooklyn, NY (US)

(72) Inventor: Eli ZHADANOV, Brooklyn, NY (US)

(21) Appl. No.: 17/447,803

(22) Filed: Sep. 15, 2021

(51) Int. Cl. A47K 7/02; B05B 1/18

(52) U.S. Cl. CPC A47K 7/028; B05B 1/185

(57) ABSTRACT

Embodiments disclosed herein relate to a showerhead attachment having an annular body; an attachment face plate coupled to the annular body; a plurality of openings formed through the attachment face plate; a plurality of protrusions extending from the attachment face plate in a direction opposite the annular body. The showerhead attachment is configured to be removably attached to a head portion of a showerhead. The plurality of openings are sized and shaped to correspond to corresponding a plurality of flow zones of the showerhead. Each flow zone includes one or more nozzles.

### BACKGROUND

Currently, there are various showerheads on the market that exhibit different properties. For example, different showerheads have different nozzles and nozzle patterns to achieve desired water pressures and/or water coverage areas. In addition, some showerheads have a number of nozzle groups arranged in various shapes on the showerhead face to achieve different flow patterns. Particularly popular are handheld showerheads that are coupled to a shower hose that can be used in close proximity for targeted use and provide better reach and added mobility unlike fixed showerheads.

Showerhead users (both fixed and handheld) often use various tools in conjunction with the showerhead. For example, users may use a hairbrush to brush their hair or some type of body scrubbing tool to wash their body while using the showerhead. However, this may require the user to use both of their hands in some cases, which may be undesirable if the user, for example, needs to use or hold some other product such as, for example, soap/shampoo, or, in the case of elderly or disabled users, needs to hold on to a grab bar in the shower.

### SUMMARY

Some exemplary embodiments include a showerhead attachment having an annular body; an attachment face plate coupled to the annular body; a plurality of openings formed through the attachment face plate; a plurality of protrusions extending from the attachment face plate in a direction opposite the annular body. The showerhead attachment is configured to be removably attached to a head portion of a showerhead. The plurality of openings are sized and shaped to correspond to corresponding a plurality of flow zones of the showerhead. Each flow zone includes one or more nozzles.

Other exemplary embodiments include a showerhead assembly having a showerhead and a showerhead attachment. The showerhead includes a head portion; a handle extending from the head portion, the handle having an inlet disposed at an end of the handle opposite the head portion; a faceplate disposed at a first side of the head portion; a plurality of nozzles extending through the faceplate, wherein the plurality of nozzles make up plurality of flow zones, wherein each flow zone is configured to create a different flow pattern, pressure, and coverage area than other ones of the plurality of flow zones; and a flow selector configured to selectively direct water through one of the plurality of flow zones. The showerhead attachment is configured to be removably attached to the head portion of the showerhead and includes an annular body; an attachment face plate coupled to the annular body; a plurality of openings formed through the attachment face plate; and a plurality of protrusions extending from the attachment face plate in a direction opposite the annular body. The plurality of openings are sized and shaped to correspond to the corresponding plurality of flow zones of the showerhead.

### BRIEF DESCRIPTION OF THE DRAWINGS

FIG. 1A shows a perspective view of an exemplary showerhead according to various exemplary embodiments.

FIG. 1B shows a front view of the exemplary showerhead of FIG. 1A.

FIG. 1C shows a rear view of the exemplary showerhead of FIG. 1A.

FIG. 2A is a perspective front view of an exemplary showerhead attachment according to various exemplary embodiments.

FIG. 2B is a perspective rear view of the exemplary showerhead attachment of FIG. 2A.

FIG. 2C is a perspective front view of an exemplary showerhead attachment according to various exemplary embodiments.

FIG. 3 is a perspective view of an exemplary showerhead with a showerhead attachment according to various exemplary embodiments.

### DETAILED DESCRIPTION

The exemplary embodiments may be further understood with reference to the following description and the related appended drawings, wherein like elements are provided with the same reference numerals. The exemplary embodiments describe a showerhead attachment having a plurality of protrusions and configured to be coupled to a showerhead without blocking the water flowing from the showerhead.

As noted above, showerhead users have typically had to hold a showerhead in one hand and any desired personal care tool (e.g., body brush/scrubber, hairbrush, etc.) in the other hand. As such, if a user needed to utilize some other product (e.g., shampoo, conditioner, body wash, etc.) in addition to the personal care tool, the user would need to put down either the showerhead or the personal care tool.

According to some exemplary embodiments, a showerhead attachment having a plurality of protrusions that may be used for scrubbing a user's body or brushing the user's hair. The showerhead attachment is configured to be coupled to a showerhead and includes a plurality of openings such that when the attachment is coupled to the showerhead, the attachment does not occlude the flow of water through the showerhead. As a result, a user may use the showerhead with the showerhead attachment with one hand, thus freeing up the other hand.

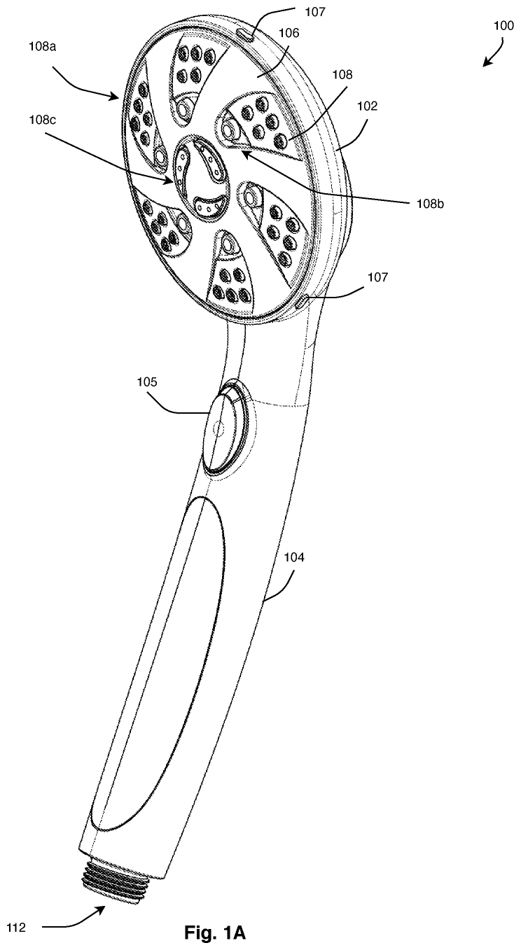

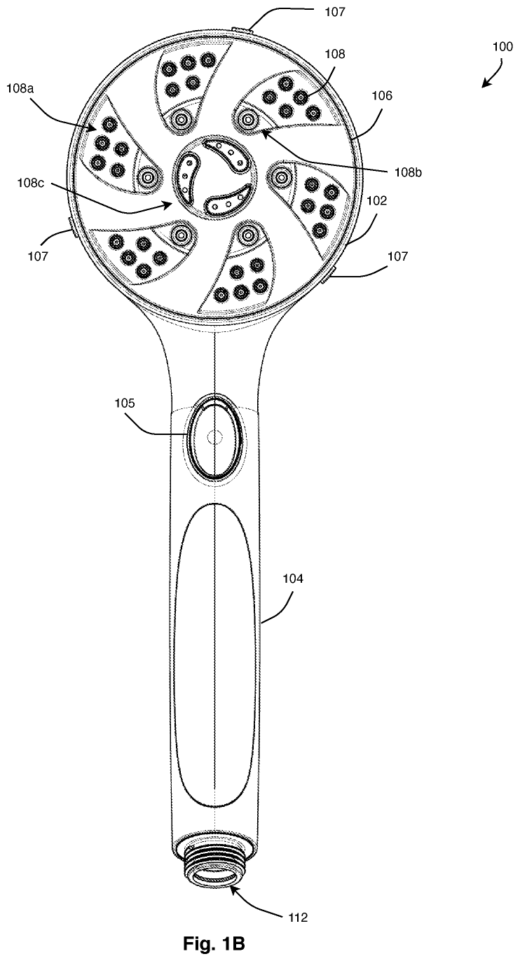

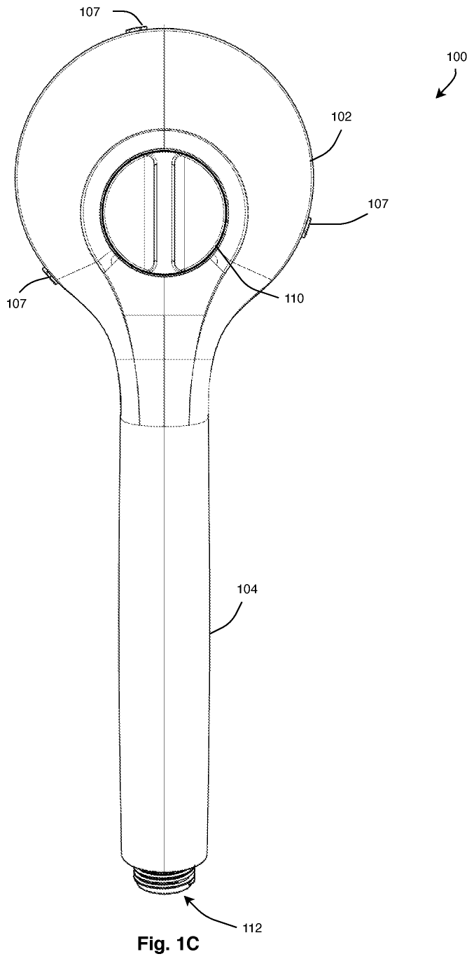

FIG. 1A shows a perspective view of an exemplary showerhead 100 according to various exemplary embodiments. FIG. 1B shows a front view of the exemplary showerhead 100 of FIG. 1A. FIG. 1C shows a rear view of the exemplary showerhead 100 of FIG. 1A. The showerhead 100 includes a head portion 102 and a handle 104 coupled to the head portion 102 and configured to be held by a user. As shown more clearly in FIG. 1A, the head portion 102 includes a faceplate 106 through which a plurality of nozzles 108 extend. The plurality of nozzles 108 may be grouped into multiple flow zones (three 108a-c shown in FIGS. 1A and 1B). Each of the multiple flow zones 108a-c creates a different flow pattern, water pressure, and/or coverage area when water flows through the corresponding zone. Although FIGS. 1A and 1B show a specific arrangement of the nozzles 108, it should be noted that the nozzles may be arranged in any other manner.

The showerhead 100 also includes a water inlet 112 through which water flows into the handle 104 and, subsequently, to the head portion 102 and through the nozzles 108. In some embodiments, the showerhead 100 may include a flow limiting switch 105 configured to allow the user to selectively reduce (or stop) and resume the flow of water through the showerhead 100.

As illustrated more clearly in FIG. 10, the showerhead 100 includes a flow selector 110 disposed on a side of the head portion 102 opposite the faceplate 106. The flow selector is configured to allow the user to selectively direct water flow through one of the multiple flow zones 108a-c. As illustrated in FIG. 1C, in some embodiments, the flow selector may be a knob configured to be turned to selectively direct water flow through one of the multiple flow zones 108a-c. However, it should be noted that the showerhead 100 may alternatively have any type of flow selector 110 that allows the user to selectively direct water flow through one of the multiple flow zones 108a-c. For example, the flow selector 110 may alternatively be a lever that can be moved between multiple positions corresponding to the multiple flow zones 108a-c.

Alternatively, the flow selector 110 may be a button that may be depressed to change the water flow to a different one of the multiple flow zones 108a-c. In some embodiments, the flow of water may be selectively reduced (or stopped) and resumed using the flow selector 110. In such an embodiment, the flow selector 110 may be moved between multiple positions corresponding to the multiple flow zones 108a-c in addition to a position that would reduce or stop the flow of water through the showerhead 100.

As illustrated in FIGS. 1A-1C, in some embodiments, the showerhead 100 includes one or more (three shown) attachment protrusions 107 extending from a perimeter of the head portion 102 and configured to facilitate the coupling of a showerhead attachment to the head portion 102, as will be described in more detail below.

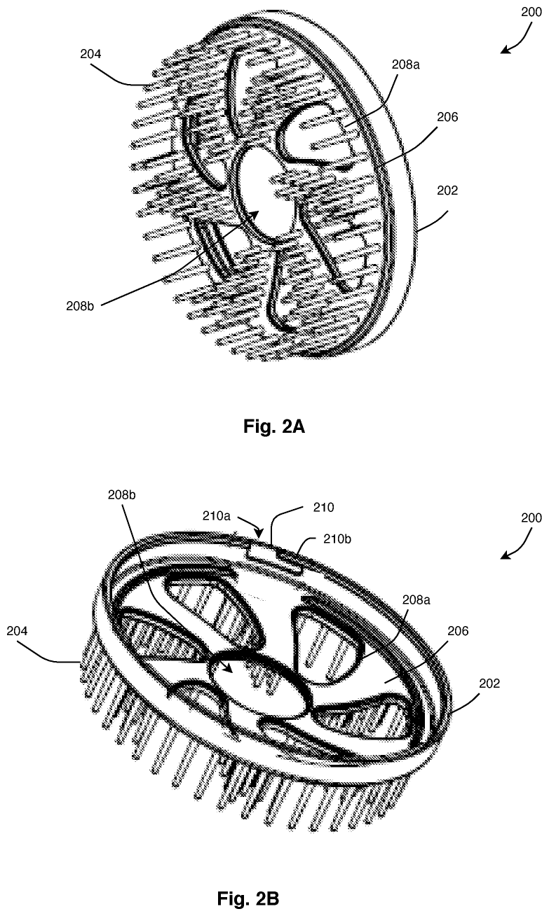

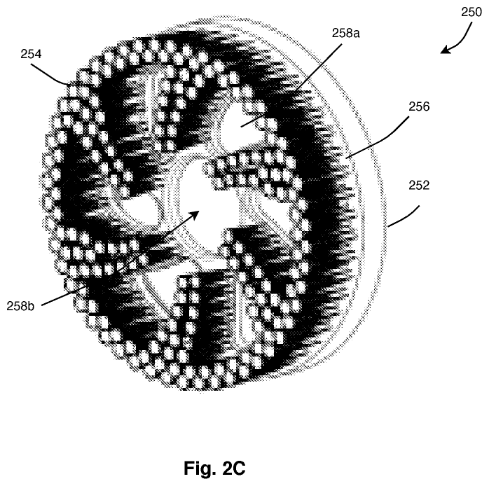

FIG. 2A is a perspective front view of an exemplary showerhead attachment 200 according to various exemplary embodiments. FIG. 2B is a perspective rear view of the exemplary showerhead attachment 200 of FIG. 2A. In some embodiments, the showerhead attachment 200 includes an annular body 202 and a face plate 206 coupled to the annular body 202. In some embodiments, the annular body 202 and the face plate 206 may be a monolithic structure. In some embodiments, the annular body 202 and the face plate 206 may alternatively be separate components that are coupled to each other.

As illustrated in FIGS. 2A and 2B, the showerhead attachment 200 includes a plurality of openings 208a, 208b extending through the face plate 206. The plurality of openings 208a, 208b are shaped and sized to correspond to the multiple flow zones 108a-c. For example, in the embodiment shown in FIGS. 2A-2B, the showerhead attachment 200 includes a plurality of first openings 208a shaped and sized to correspond to first and second flow zones 108a, 108b of the showerhead 100 and a second opening 208b shaped and sized to correspond to a third flow zone 108c of the showerhead 100.

In some embodiments, the showerhead attachment 200 includes a plurality of protrusions 204 extending from the face plate 206 in a direction opposite the annular body 202. In some embodiments, the annular body 202, the face plate 206, and the plurality of protrusions form a monolithic structure. In some embodiments, the showerhead attachment 200 (including the plurality of protrusions 204) may be formed of a semi-compliant material such as, for example, polyethylene. The plurality of protrusions 204 may have any length and thickness suitable for a particular use (e.g., brushing hair, neck massaging, foot scrubbing, etc.).

As shown more clearly in FIG. 2B, in some embodiments, the showerhead attachment 200 may include one or more recesses 210 formed in an inner surface of the annular body 202. Each of the one or more recesses 210 are configured to receive a corresponding one of the one or more attachment protrusions 107 of the showerhead 100. As illustrated in FIG. 2B, each recess 210 includes an insertion opening 210a and a groove 210b extending from the insertion opening 210a. The insertion opening 210a receives the attachment protrusion 107 when the showerhead attachment 200 is placed onto the head portion 102 of the showerhead 100.

Subsequently, the showerhead attachment 200 is rotated such that the attachment protrusion is moved into the groove 210b, thus maintaining the attachment of the showerhead attachment 200 to the head portion 102. It should be noted however, that any coupling mechanism may be used to removably couple the showerhead attachment 200 to the head portion 102. For example, the annular body 202 may alternatively include an inwardly extending protrusion that is configured to be received in an annular groove formed in the head portion 102.

In some embodiments, the plurality of protrusions 204 may alternatively be bristles, as depicted in FIG. 2C, which shows a perspective front view of an exemplary showerhead attachment 250 according to various exemplary embodiments. Similar to the showerhead attachment 200, the showerhead attachment 250 includes an annular body 252 and a faceplate 256 having a plurality of openings 258a, 258b sized and shaped to correspond to the plurality of flow zones 108a-c. Although not shown in FIG. 2C, the showerhead attachment 250 also includes the one or more recesses 210 formed on the inner surface of the annular body 252.

In some embodiments, the protrusions of the showerhead attachment 250 are a plurality of bristles 254. In some embodiments, the annular body 252 and the faceplate 256 may be formed of a hard material and the bristles 254 may be formed of a soft and flexible material. For example, the annular body 252 and the faceplate 256 may be formed of a hard plastic such as acrylonitrile butadiene styrene (ABS) plastic and the bristles 254 and may be formed of nylon, horse hair, boar hair, or other suitable materials. When coupled to the showerhead 100, the showerhead attachment 250 may be used for scrubbing such as, for example, scrubbing a user's body. However, it should be noted that the showerhead attachment 250 (and the showerhead attachment 200) may be used for any purpose.

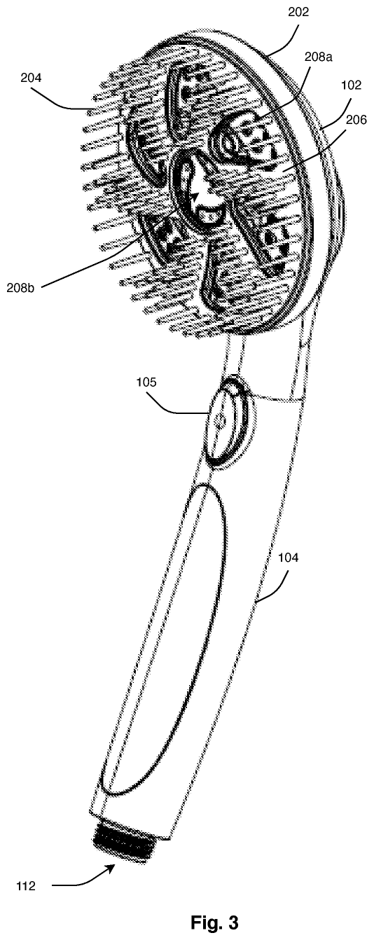

FIG. 3 is a perspective view of an exemplary showerhead assembly having the showerhead 100 with a showerhead attachment 200 attached to it according to various exemplary embodiments. As illustrated in FIG. 3, the first and second flow zones 108a, b (not labeled in FIG. 3 for clarity), are entirely contained within the plurality of first openings 208a and the third flow zone 108c (also not labeled in FIG. 3) is entirely contained within the second opening 208b.

As a result, the attachment 200 does not interfere with the flow of water through any of the nozzles 108 of any of the multiple flow zones 108a-c. Although a specific configuration of the flow zones 108a-c and the corresponding openings 208a and 208b is shown, it should be noted that the flow zones and the corresponding openings may have any number, size, and shape as long as the openings are sized and shaped to allow water to flow through the nozzles 108 without the showerhead attachment 200 interfering with the flow.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A showerhead attachment, comprising:
an annular body;
an attachment face plate coupled to the annular body;
a plurality of openings formed through the attachment face plate;
a plurality of protrusions extending from the attachment face plate in a direction opposite the annular body,
wherein the showerhead attachment is configured to be removably attached to a head portion of a showerhead,
wherein the plurality of openings are sized and shaped to correspond to corresponding a plurality of flow zones of the showerhead, and
wherein each flow zone includes one or more nozzles.

2. The showerhead attachment of claim 1, wherein the annular body, the attachment face plate, and the plurality of protrusions form a monolithic structure.

3. The showerhead attachment of claim 2, wherein the monolithic structure is formed of a semi-compliant material.

4. The showerhead attachment of claim 1, wherein the plurality of protrusions comprises a plurality of bristles.

5. The showerhead attachment of claim 4, wherein the annular body and the attachment face plate form a monolithic structure.

6. The showerhead attachment of claim 5, wherein the monolithic structure is formed of a hard plastic.

7. The showerhead attachment of claim 1, wherein the plurality of openings are configured not to block the plurality of flow zones.

8. The showerhead attachment of claim 1, further comprising:
one or more recesses formed in an inner surface of the annular body, wherein the one or more recesses are configured to receive corresponding one or more attachment protrusions of the showerhead to removably couple the showerhead attachment to the showerhead.

9. A showerhead assembly, comprising:
a showerhead, comprising:
a head portion;
a handle extending from the head portion, the handle having an inlet disposed at an end of the handle opposite the head portion;
a faceplate disposed at a first side of the head portion;
a plurality of nozzles extending through the faceplate, wherein the plurality of nozzles make up plurality of flow zones, wherein each flow zone is configured to create a different flow pattern, pressure, and coverage area than other ones of the plurality of flow zones; and
a flow selector configured to selectively direct water through one of the plurality of flow zones; and
a showerhead attachment configured to be removably attached to the head portion of the showerhead, the showerhead attachment comprising:
an annular body;
an attachment face plate coupled to the annular body;
a plurality of openings formed through the attachment face plate; and
a plurality of protrusions extending from the attachment face plate in a direction opposite the annular body,
wherein the plurality of openings are sized and shaped to correspond to the corresponding plurality of flow zones of the showerhead.

10. The showerhead assembly of claim 9, wherein the showerhead further comprises one or more attachment protrusions extending radially outwardly from the head portion, wherein the showerhead attachment further comprises one or more recesses formed in an inner surface of the annular body, wherein the one or more recesses are configured to receive corresponding ones of the one or more attachment protrusions to removably couple the showerhead attachment to the showerhead.

11. The showerhead assembly of claim 9, wherein the annular body, the attachment face plate, and the plurality of protrusions form a monolithic structure.

12. The showerhead assembly of claim 11, wherein the monolithic structure is formed of a semi-compliant material.

13. The showerhead assembly of claim 9, wherein the plurality of protrusions comprises a plurality of bristles.

14. The showerhead assembly of claim 13, wherein the annular body and the attachment face plate form a monolithic structure.

15. The showerhead assembly of claim 14, wherein the monolithic structure is formed of a hard plastic.

16. The showerhead assembly of claim 9, wherein the plurality of openings are configured not to block the plurality flow zones.

17. The showerhead assembly of claim 9, further comprising:
one or more recesses formed in an inner surface of the annular body, wherein the one or more recesses are configured to receive corresponding one or more attachment protrusions of the showerhead to removably couple the showerhead attachment to the showerhead.

18. The showerhead assembly of claim 9, wherein the showerhead further comprises:
a flow selector configured to selectively direct water flow through one of the plurality of flow zones.

19. The showerhead assembly of claim 9, wherein the showerhead further comprises:
a flow limiting switch configured to selectively stop and resume water flow through the showerhead.

20. The showerhead assembly of claim 9, wherein the flow selector is disposed on a second side of the head portion opposite the first side.
